(19) United States
(12) Patent Application Publication
(10) Pub. No.: US 2026/0174619 A1
(43) Pub. Date: Jun. 25, 2026

(54) BEAUTY APPARATUS

(71) Applicants: Po-Chang LIU, TAOYUAN CITY (TW); BIBOTING INTERNATIONAL CO., LTD., TAOYUAN CITY (TW)

(72) Inventors: Li-Pin YUAN, Taoyuan City (TW); Po-Chang LIU, TAOYUAN CITY (TW)

(21) Appl. No.: 19/000,645

(22) Filed: Dec. 23, 2024

(51) Int. Cl. A61H 7/00; A61H 23/02

(52) U.S. Cl. CPC A61H 7/008; A61H 23/02; A61H 2205/024

(57) ABSTRACT

A beauty apparatus having a main case, a first electrode member, and a plurality of second electrode members is provided. The main case has an attaching portion, a negative pressure inlet, and a negative pressure outlet. The negative pressure inlet is arranged on the attaching portion and communicated to the negative pressure outlet. The first electrode member is arranged on the attaching portion and includes a connection ring surrounding the negative pressure inlet and a plurality of extending electrodes. The extending electrodes extend from the connection ring in a direction away from the negative pressure inlet. The second electrode members are arranged on the attaching portion, surround the connection ring, and are misaligned with the extending electrodes. A gap is formed between the first electrode member and each of the second electrode members. The beauty apparatus is therefore simultaneously performing vacuum adsorption and microcurrent stimulation on a skin.

### BACKGROUND

### Technical Field

The present disclosure relates to the field of beauty and health care, particularly to a beauty apparatus.

### Description Of Related Art

In daily life, many people use device such as massagers or beauty devices to care for their skin for beauty care and skin conditioning. However, the function of existing massager or existing beauty device is single, the user need to buy different massagers or beauty devices with different functions for different effects of beauty, skin care, or massage, this requires high costs and cause inconvenience in storage and carrying. Therefore, how to design a beauty apparatus with multiple functions is an object that needs to be achieved.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to simultaneously perform vacuum adsorption and microcurrent stimulation on a skin.

To accomplish the aforementioned objective, the present disclosure provides a beauty apparatus having a main case, a first electrode member, and a plurality of second electrode members. The main case has an attaching portion, a negative pressure inlet, and a negative pressure outlet. The negative pressure inlet is arranged on the attaching portion and communicated to the negative pressure outlet. The first electrode member is arranged on the attaching portion and includes a connection ring and a plurality of extending electrodes. The connection ring surrounds the negative pressure inlet. Each of the extending electrodes is extended from the connection ring in a direction away from the negative pressure inlet. Each of the second electrode members is arranged on the attaching portion, surrounds the connection ring, and is misaligned with each of the extending electrodes. A gap is formed between the first electrode member and each of the second electrode members.

Another aspect of the present disclosure provides that each of the extending electrodes is arranged radially, and each of the second electrode members and each of the extending electrodes are arranged in a staggered order and at intervals.

Another aspect of the present disclosure provides that the first electrode member and each of the second electrode members are coplanar, and the first electrode member and each of the second electrodes members are electrodes with opposite electrical polarity.

Another aspect of the present disclosure provides that the attaching portion is located on an end of the main case, and the negative pressure outlet is located on another end of the main case away from the negative pressure inlet.

Another aspect of the present disclosure provides that further includes a connecting tube, the connecting tube is arranged in the main case, two ends of the connecting tube are respectively communicated to the negative pressure inlet and the negative pressure outlet.

Another aspect of the present disclosure provides that the main case includes a first case and a second case, the first case is assembled to the second case, and the first case has the attaching portion.

Another aspect of the present disclosure provides that further includes a third electrode member, the third electrode member is a hollow ring and is sandwiched between the first case and the second case, and the first electrode member and the third electrodes member are electrodes with opposite electrical polarity.

Another aspect of the present disclosure provides that further includes a pair of waterproof rings, one of the waterproof rings is arranged between the first case and the third electrode member, and another one of the waterproof rings is arranged between the second case and the third electrode member.

Another aspect of the present disclosure provides that further includes a phototherapy module, the phototherapy module is arranged on the main case and includes a base plate and a plurality of phototherapy lights, and each of the phototherapy lights is arranged on the base plate and configured to correspond to each of the gaps.

Another aspect of the present disclosure provides that the phototherapy module further includes a transparent cover, the transparent cover is arranged between the main case, the first electrode member, and each of the second electrode members.

Another aspect of the present disclosure provides that further includes a periocular massager, the periocular massager is detachably arranged on the main case and opposite to the attaching portion, and the periocular massager has a pair of convex cylinders arranged at intervals.

Another aspect of the present disclosure provides that the convex cylinders are electrodes with opposite electrical polarity.

Another aspect of the present disclosure provides that further includes an electronic control module, the electronic control module is arranged in the main case and electrically connected to the first electrode member and each of the second electrode members.

Another aspect of the present disclosure provides that further includes a vibration motor, the vibration motor is arranged in the main case and electrically connected to the electronic control module.

Another aspect of the present disclosure provides that the electronic control module includes a circuit board and a power source, and the power source, the first electrode member and each of the second electrode members are electrically connected to the circuit board.

In the present disclosure, the beauty apparatus may achieve a skin-lifting effect by vacuum adsorption when used with a negative pressure massage machine, as the main case has a negative pressure inlet communicated to the negative pressure outlet. The first electrode member and each of the second electrode members of the beauty apparatus surround a periphery of the negative pressure inlet, and a gap is formed between the first electrode member and each of the second electrode members, such that the first electrode member and each of the second electrode members may form a circuit loop with a skin to achieve microcurrent stimulation. Therefore, the beauty apparatus may simultaneously perform vacuum adsorption and microcurrent stimulation on the skin.

### BRIEF DESCRIPTION OF THE DRAWINGS

FIG. 1 is a perspective appearance view of the present disclosure;

FIG. 2 is an exploded view of the present disclosure;

FIG. 3 is a partial exploded view of the present disclosure;

FIG. 4 is another partial exploded view of the present disclosure;

FIG. 5 is a cross-sectional side view of the present disclosure; and

FIG. 6 is a cross-sectional top view of the present disclosure.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

As used herein and not otherwise defined, the terms “substantially” and “approximately” are used to describe and describe small changes. When used in connection with an event or situation, the terms may include the precise moment at which the event or situation occurs, as well as the event or situation occurring to a close approximation. For example, when combined with a numerical value, the terms may include a range of variation equal to or less than ±5% of the numerical value, such as equal to or less than ±4%, equal to or less than ±3%, equal to or less than ±2%, equal to or less than ±1%, equal to or less than ±0.5%, equal to or less than ±0.1%, or equal to or less than ±0.05%.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

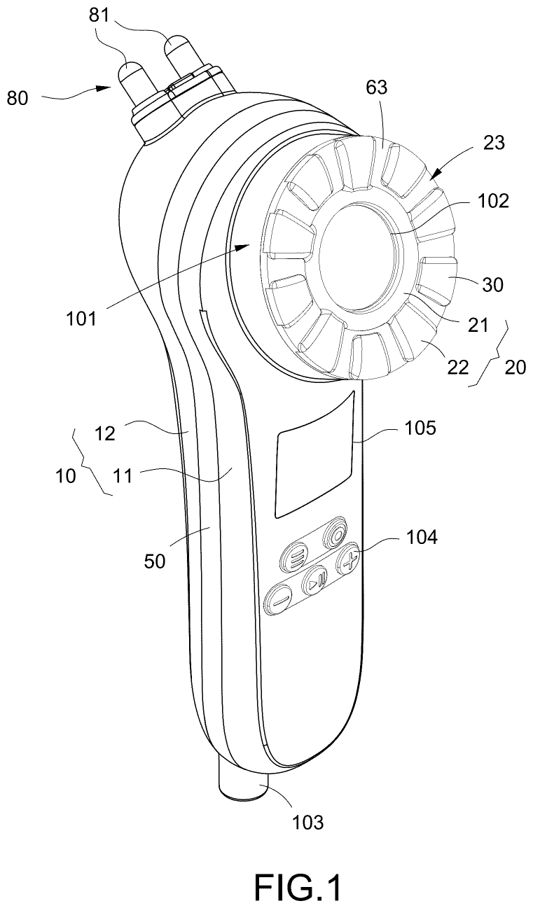

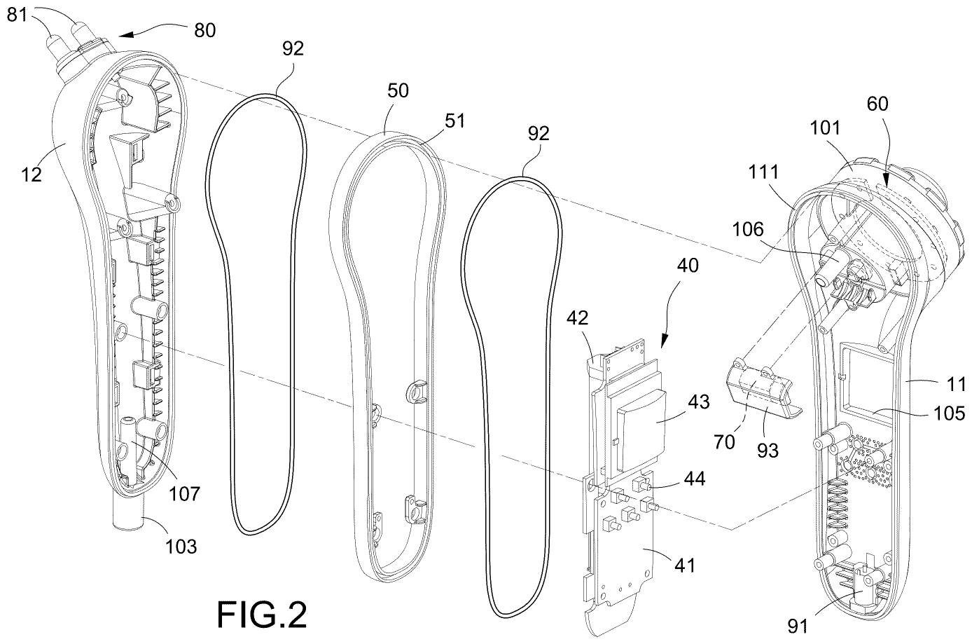

The present disclosure provides a beauty apparatus, which may be used with a negative pressure massage machine (not shown in figures) to achieve a skin-lifting effect by vacuum adsorption, but the beauty apparatus of the present disclosure may also be used alone, details are provided as later. Please refer to FIG. 1 and FIG. 2, the beauty apparatus of the present disclosure includes a main case 10, a first electrode member 20, and a plurality of second electrode members 30.

The main case 10 is rod-shaped for easy grabbing and operating by user. The main case 10 has an attaching portion 101, a negative pressure inlet 102, and a negative pressure outlet 103. In the embodiment, the attaching portion 101 is extended from an end of the main case 10, but the present disclosure is not limited to this embodiment. The negative pressure inlet 102 is arranged on the attaching portion 101, and the negative pressure inlet 102 is communicated to the negative pressure outlet 103. In detail, an accommodating space (not labeled in figures) is formed inside the main case 10 for accommodating an electronic control module 40, such that the negative pressure inlet 102 is communicated to the negative pressure outlet 103 through the accommodating space. Therefore, the negative pressure massage machine may connect the negative pressure outlet 103 by a hose (not shown in figures) to be communicated to the negative pressure inlet 102. The user may grab the main case 10 to make the negative pressure inlet 102 to attach a skin of the user to achieve a skin-lifting effect by vacuum adsorption when the negative pressure massage machine is vacuuming.

The first electrode member 20 and each of the second electrode members 30 are arranged on the attaching portion 101, and the first electrode member 20 and each of the second electrode members 30 are electrodes with opposite electrical polarity. In detail, each of the second electrode members 30 is negative electrode when the first electrode member 20 is positive electrode, and each of the second electrode members 30 is positive electrode when the first electrode member 20 is negative electrode. In the embodiment, the first electrode member 20 and each of the second electrode members 30 are substantially coplanar. In another embodiment, there may be some slight step difference between the first electrode member 20 and each of the second electrode members 30, or an outer edge of the first electrode member 20 and each of the second electrode members 30 may form a chamfer, but the above embodiments still fall within the protection scope of the present disclosure. The electronic control module 40 is electrically connected to the first electrode member 20 and each of the second electrode members 30. The first electrode member 20 includes a connection ring 21 and a plurality of extending electrodes 22. The connection ring 21 surrounds a periphery of the negative pressure inlet 102. The shape of the connection ring 21 is corresponding to the shape of the negative pressure inlet 102. In the embodiment, the negative pressure inlet 102 is a circle hole, the connection ring 21 is configured to be ring-shaped, but the present disclosure is not limited to this embodiment. Each of the extending electrodes 22 is extended from a periphery of the connection ring 21 in a direction away from the negative pressure inlet 102. Each of the second electrode members 30 surrounds the connection ring 21 and is misaligned with each of the extending electrodes 22. The first electrode member 20 and each of the second electrode members 30 do not contact each other, that is a gap 23 formed between the first electrode member 20 and each of the second electrode members 30.

Details are provided as follows. The electronic control module 40 in the embodiment includes a circuit board 41 a power source 42, a display screen 43, and a plurality of control buttons 44, but the present disclosure is not limited to this embodiment. The power source 42, the display screen 43, each of the control buttons 44, the first electrode member 20, and each of the second electrode members 30 are electrically connected to the circuit board 41. The power source 42 may be a battery or a rechargeable battery to provide power to the electronic control module 40 such that the beauty apparatus of the present disclosure may be operated without connecting a power cord (not shown in figures). In addition, the beauty apparatus of the present disclosure further includes a DC connector 91 arranged on an end of the main case 10 and electrically connected to the circuit board 41, such that the DC connector 91 may connect the power cord to power source 42 outside to provide power therefrom. Therefore, the user may use the beauty apparatus by connecting the power cord outside to supply power if the power of the power source 42 is not sufficient. The main case 10 has a plurality of keys 104 corresponding to each of the control buttons 44, such that the user may press each of the keys 104 to touch and press each of the control buttons 44 to operate the beauty apparatus of the present disclosure. Therefore, when the user starts up the electrotherapy function of the beauty apparatus of the present disclosure by operate the control buttons 44 and put the first electrode member 20 and each of the second electrode members 30 of the attaching portion 101 on the skin, the first electrode member 20, each of the second electrode members 30, and the skin may form a circuit loop to make a microcurrent to act on the skin to achieve a microcurrent stimulation effect. It is worth noting that the electrotherapy function may be used together with the vacuum adsorption function of the negative pressure massage machine, but the electrotherapy function may also be used alone. In addition, the main case 10 has a window 105 corresponding to the display screen 43 for the user to know the status and usage mode of the beauty apparatus of the present disclosure. In the embodiment, the window 105 is a through slot that passes through one side of the main case 10 for accommodating the display screen 43, but the window 105 may also be a transparent acrylic or a transparent glass for the user to read the display screen 43 inside the main case 10 in another embodiment.

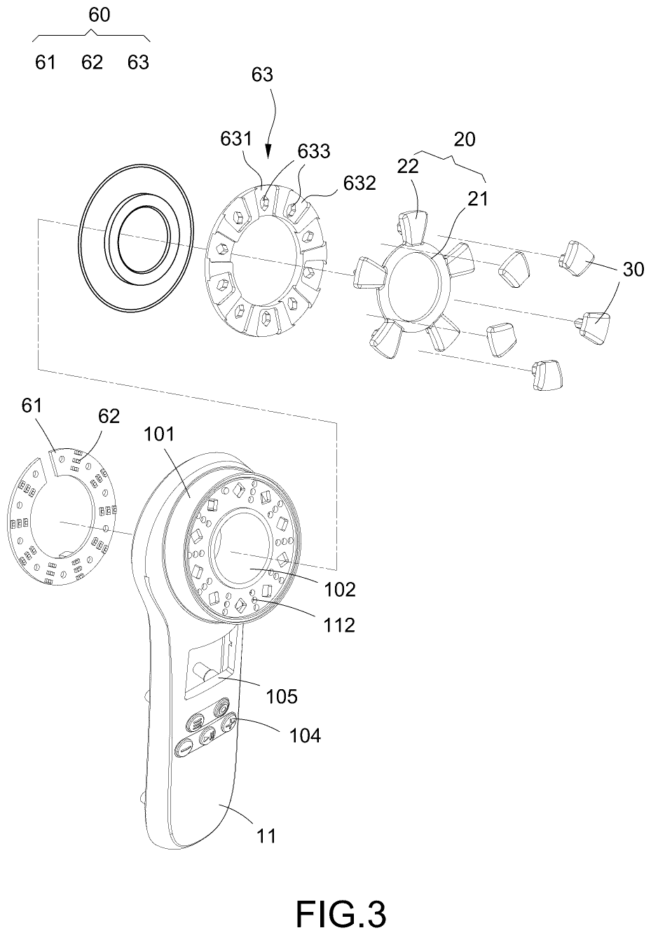

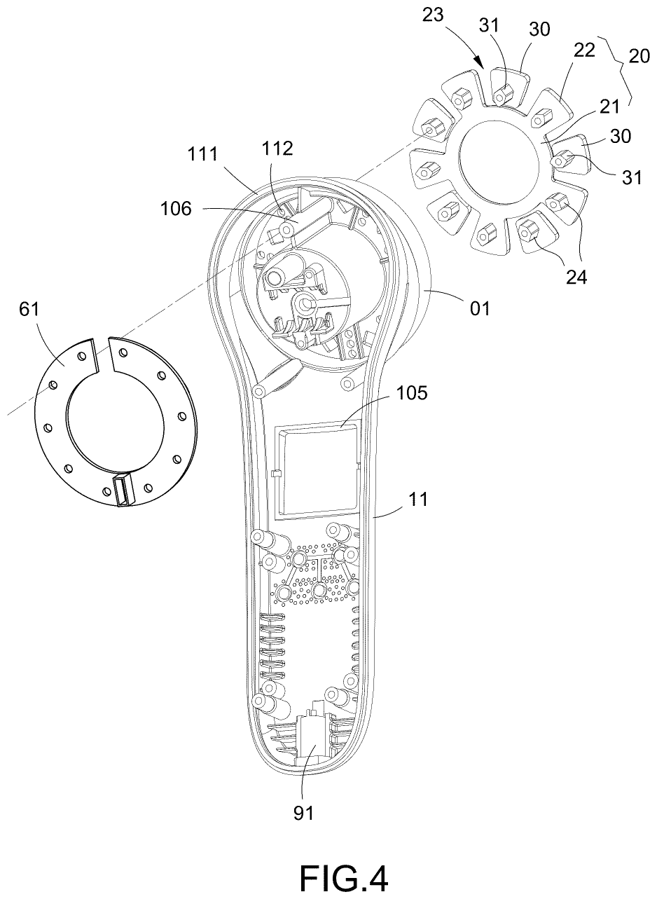

Details are provided as follows. Please refer to FIG. 1, FIG. 2, FIG. 3, and FIG. 4. In the embodiment, each of the extending electrodes 22 of the first electrode member 20 is arranged radially to connect to the connecting ring 21, and each of the second electrode members 30 and each of the extending electrodes 22 are arranged in a staggered order and at intervals, but the present disclosure is not limited to this embodiment. That is, the present disclosure does not limit the arrangement of each of the extending electrodes 22 and each of the second electrode members 30 as long as the first electrode member 20 does not contact each of the second electrode members 30. In addition, a number of the extending electrodes 22 and a number of the second electrode members 30 in the embodiment are equal. Since each of the extending electrodes 22 is arranged radially to connect to the connecting ring 21, each of the second electrode members 30 and each of the extending electrodes 22 are arranged in a staggered order and at intervals, and the number of the extending electrodes 22 and the number of the second electrode members 30 are equal, each of the extending electrodes 22 is adjacent to two second electrode members 30 and each of the second electrode members 30 is adjacent to two extending electrodes 22 while the extending electrodes 22 and the second electrode members 30 may be respectively arranged in a ring-shaped configuration. Therefore, the microcurrent may evenly act on the skin around the negative pressure inlet 102 when the user is using the beauty apparatus of the present disclosure, so as to achieve the microcurrent stimulation effect. In the embodiment, each of the extending electrodes 22 and each of the second electrode members 30 are trapezoid shape, but the present disclosure is not limited to this embodiment, a shape of each of the extending electrodes 22 and a shape of d each of the second electrode members 30 may be modified according different requirements.

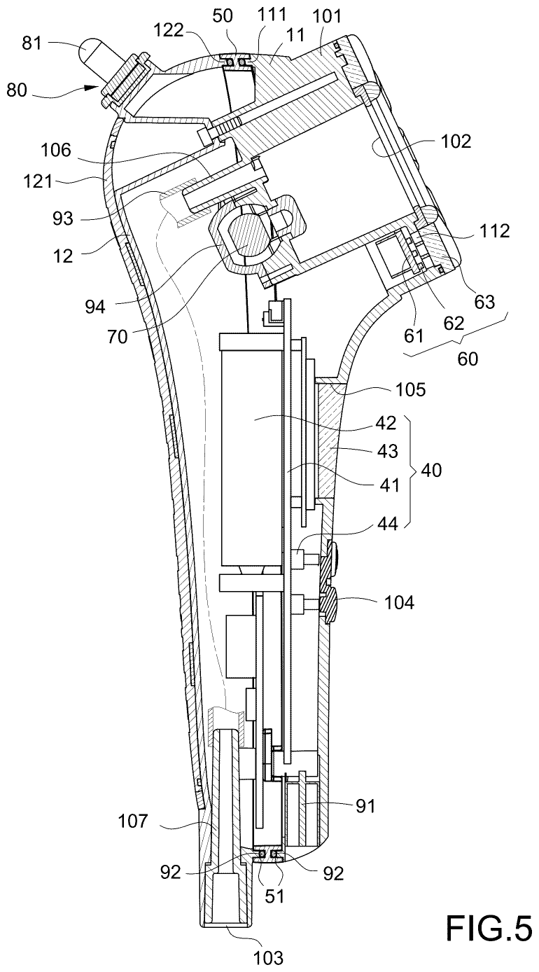

Please refer to FIG. 1, FIG. 2, FIG. 3, FIG. 4, and FIG. 5. The main case 10 in the embodiment includes a first case 11 and a second case 12. The first case 11 is assembled to the second case 12 to form the accommodating space. In detail, the first case 11 and the second case 12 of the main case 10 in the embodiment are assembled along a front-rear direction of the main case 10, but the first case 11 and the second case 12 may also be assembled along an up-down direction or a left-right direction in other embodiments. Therefore, the electronic control module 40 is sandwiched and fixed between the first case 11 and the second case 12, and a limiting structure may be arranged inside the first case 11 and the second case 12 to position the electronic control module 40. The first case 11 has the attaching portion 101, the window 105, and each of the keys 104. An anti-slip cover 121 is arranged on the second case 12 to avoid slipping when the user grabs the main case 10. A location of the anti-slip cover 121 on the second case 12 is configured to correspond at least to the window 105 and each of the keys 104 of the first case 11, but the location of the anti-slip cover 121 on the second case 12 may also be further configured to correspond to the attaching portion 101.

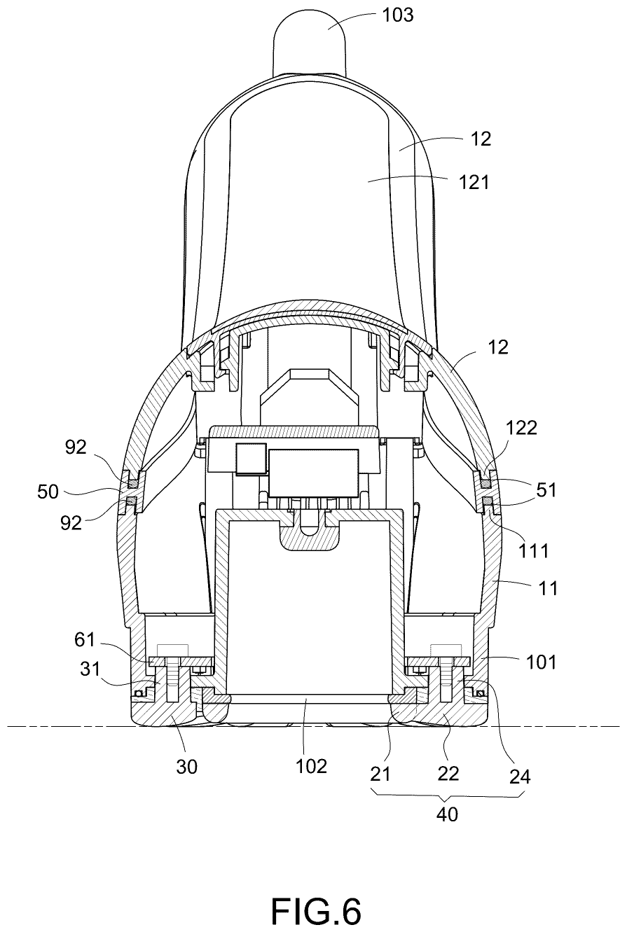

Please refer to FIG. 1, FIG. 2, and FIG. 6. The beauty apparatus of the present disclosure further includes a third electrode member 50. The third electrode member 50 is a hollow ring, and the third electrode member 50 is sandwiched between the first case 11 and the second case 12. In detail, a shape of the hollow ring of the third electrode member 50 is not annular, but is approximately a keyhole-shaped corresponding to a shape of a joint between the first case 11 and the second case 12. Nevertheless, the present disclosure is not limited to this embodiment. The first electrode member 20 and the third electrodes member 30 are electrodes with opposite electrical polarity. In other words, each of the second electrode members 30 and the third electrode member 50 are electrodes with the same electrical polarity. Therefore, when the user grabs the main case 10 to make the first electrode member 20 of the attaching portion 101 to attach the skin, the user may grab the third electrode member 50 between the first case 11 and the second case 12 at the same time, such that the first electrode member 20 and the third electrode member 50 may also form a circuit loop with a human body to achieve microcurrent stimulation on the skin.

Details are provided as follows. In order to ensure the waterproof performance of the main case 10, the beauty apparatus according to the embodiment of the present disclosure further includes a pair of waterproof rings 92. One of the waterproof rings 92 is arranged between the first case 11 and the third electrode member 50, and another one of the waterproof rings 92 is arranged between the second case 12 and the third electrode member 50, as shown in FIG. 6. In detail, an embedded groove 51 is defined on two opposite sides of the third electrode member 50 facing the first case 11 and the second case 12, a first embedded strip 111 is formed on a side of the first case 11 facing the third electrode member 50, and a second embedded strip 122 is formed on a side of the second case 12 facing the third electrode member 50. Each of the waterproof rings 92 is accommodated in each of the embedded grooves 51 located on two sides of the third electrode member 50. The first embedded strip 111 and the second embedded strip 122 are respectively inserted and fixed in each of the embedded grooves 51 to abut against each of the waterproof rings 92, such that the first case 11 and the second case 12 may be fixed to the third electrode member 50. In addition, each of the waterproof rings 92 may ensure the waterproof performance of the joints of the first case 11, the second case 12, and the third electrode member 50, so as to protect and prevent the electronic control module 40 from damaging due to moisture or water intrusion.

Please refer again to FIG. 1, FIG. 2, and FIG. 5. The negative pressure outlet 103 in the embodiment is located on an end of the main case 10 away from the negative pressure inlet 102, but the present disclosure is not limited to this embodiment. For example, the negative pressure outlet 103 may also be located on a side of the main case 10. In the embodiment, the negative pressure inlet 102 is located on the first case 11 because the negative pressure inlet 102 is arranged on the attaching portion 101, the negative pressure outlet 103 is arranged on the second case 12, but the negative pressure outlet 103 may also be arranged on the first case 11 in another embodiment. The beauty apparatus according to the embodiment of the present disclosure further includes a connecting tube 93. The connecting tube 93 is arranged in the accommodating space of the main case 10, and two ends of the connecting tube 93 are respectively communicated to the negative pressure inlet 102 and the negative pressure outlet 103. In detail, as shown in FIG. 5. The main case 10 has an inlet port 106 communicated to the negative pressure inlet 102 and an outlet port 107 communicated to the negative pressure outlet 103. The inlet port 106 is a hollow tube structure extended from the attaching portion 101 of the first case 11 toward the accommodating space. The outlet port 107 is a hollow tube structure extended from a bottom end of the second case 12 toward the accommodating space. Two ends of the connecting tube 93 are respectively adapted to sheathe the inlet port 106 and the outlet port 107. Since the negative pressure outlet 103 and the outlet port 107 in the embodiment are arranged on the second case 12, and the inlet port 106 is extended from the attaching portion 101 toward the accommodating space, the connecting tube 93 may be substantially parallel to the first case 12 without interfering with the electronic control module 40.

Details are provided as follows. The negative pressure inlet 102 and the negative pressure outlet 103 may be directly communicated through the connecting tube 93, such that the negative pressure massage machine may make the negative pressure inlet 102 to stably and quickly perform vacuum adsorption to the skin of the user when the negative pressure massage machine is vacuuming. In addition, when a dirt or essential oil is on the skin of the user, the dirt or essential oil may be transported to connecting tube 93, the negative pressure outlet 103, the hose, and the negative pressure massage machine in sequence after entering the negative pressure inlet 102, such that the dirt or essential oil may not remain in the accommodating space of the main case 10 to cause damage to the electronic control module 40 or other components.

Please refer again to FIG. 2 and FIG. 5, the beauty apparatus of the present disclosure further includes a phototherapy module 60. The phototherapy module 60 is arranged on the main case 10, and the phototherapy module 60 mainly includes a base plate 61 and a plurality of phototherapy lights 62. The base plate 61 is arranged on an inner surface of the first case 11 corresponding to the attaching portion 101. Each of the phototherapy lights 62 is arranged on the base plate 61 and electrically connected to the electronic control module 40. Therefore, the user may start up the phototherapy function of the beauty apparatus of the present disclosure by operating the control buttons 44, that makes each of the phototherapy lights 62 to glow through the electronic control module 40. A plurality of through holes 112 is defined at a plurality of locations of the first case 11 corresponding to each of the gaps 23, such that each of the through holes 112 is used to accommodate each of the phototherapy lights 62. Each of the phototherapy lights 62 is accommodated in each of the through holes 112 to be configured to correspond each of the gaps 23, such that the light emitted by each of the phototherapy lights 62 may irradiate to outside through each of the gaps 23. In the embodiment, each of the phototherapy lights 62 is infrared LED to irradiate the skin to promote wound healing, promote scar repair, improve skin inflammation, relieve skin discomfort, promote hair growth, and improve sleep . . . etc. when the user uses it, but the present disclosure is not limited to this embodiment. For example, each of the phototherapy lights 62 may also be blue LED, green LED, white LED, purple LED, orange LED, yellow LED or a combination of the above to achieve different phototherapy effects.

In addition, the phototherapy module 60 in the embodiment further includes a transparent cover 63. The transparent cover 63 is arranged between the main case 10, the first electrode member 20, and each of the second electrode members 30. In detail, the transparent cover 63 is arranged on the attaching portion 101 of the first case 11, and the first electrode member 20 and each of the second electrode members 30 are arranged on the transparent cover 63. The transparent cover 63 defines a plurality of first fixing grooves 631, a plurality of second fixing grooves 632, and a plurality of positioning holes 633. Each of the positioning holes 633 is located in each pf the first fixing grooves 631 and each of the second fixing grooves 632. The first electrode member 20 has a plurality of first positioning columns 24, and each of the second electrode members 30 has a plurality of second positioning columns 31. A part of the first electrode member 20 is fixed in each of the first fixing grooves 631, another part of the first electrode member 20 is exposed outside the transparent cover 63, and each of the first positioning columns 24 is embedded and fixed in each of the positioning holes 633 of each of the first fixing grooves 631. A part of each of the second electrode members 30 is fixed in each of the second fixing grooves 632, another part of each of the second electrode members 30 is exposed outside the transparent cover 63, and each of the second positioning columns 31 is embedded and fixed in each of the positioning holes 633 of each of the second fixing grooves 632. Therefore, the first electrode member 20 and each of the second electrode members 30 are not only fixed to the transparent cover 63, but also positioned to prevent from rotating relative to the transparent cover 63. On the other hand, since the transparent cover 63 covers each of the through holes 112 of the first case 11, each of the phototherapy lights 62 may be protected and prevented from exposing, and the light emitted by each of the phototherapy lights 62 may pass through the transparent cover 63 because of transparency thereof. In addition, each of the first positioning columns 24 and each of the second positioning columns 31 are abutted against to the base plate 61 of the phototherapy module 60 after passing through the transparent cover 63, so as to be screwed and fixed on the base plate 61 by a plurality of screws (as shown in FIG. 6, not labeled in figures).

Please refer again to FIG. 2, FIG. 5, and FIG. 6, the beauty apparatus of the present disclosure further includes a vibration motor 70. The vibration motor 70 is arranged in the main case 10 and configured to correspond to the attaching portion 101. In detail, the vibration motor 70 is mounted on the inner surface of the first case 11 by a fixing bracket 94. The vibration motor 70 is electrically connected to the electronic control module 40. Therefore, the user may start up the vibration function of the beauty apparatus of the present disclosure by operating the control buttons 44 to relieve stress, relax muscles and increase blood flow by relieving muscle fibers in the superficial and deep layers of the skin.

Please refer again to FIG. 1, FIG. 2, and FIG. 5, the beauty apparatus of the present disclosure further includes a periocular massager 80. The periocular massager 80 is detachably arranged on the main case 10 and opposite to the attaching portion 101. In detail, the periocular massager 80 is detachably arranged on the second case 12 to be configured to a front side and a rear side of the main case 10 together with the attaching portion 101 of the first case 11. In the embodiment, the periocular massager 80 is arranged on the second case 12 by magnetic method for the user conveniently detaching and assembling the periocular massager 80, but the present disclosure is not limited to this embodiment. For example, the periocular massager 80 may also be arranged on the main case 10 by buckle method, lock method, or embedded method. The periocular massager 80 has a pair of convex cylinders 81 arranged at intervals. Each of the convex cylinders 81 is extended along a direction away from the main case 10. Therefore, the user may slightly force each of the convex cylinders 81 corresponding to a depression of a skull at the lower edge of the eyebrow when grabbing the main case 10, so as to activate blood circulation around the eyes and reduce intraocular pressure. In addition, the convex cylinders 81 in the embodiment are electrodes with opposite electrical polarity and electrically connected to the circuit board 41 of the electronic control module 40. Namely, one of the convex cylinders 81 is electrically connected to a positive electrode of the circuit board 41, and another one of the convex cylinders 81 is electrically connected to a negative electrode of the circuit board 41. Therefore, when the user uses each of the convex cylinders 81 of the periocular massager 80 to massage the periocular area, each of the convex cylinders 81 and the skin may also form the circuit loop to achieve microcurrent stimulation.

In the present disclosure, the beauty apparatus may achieve the skin-lifting effect by vacuum adsorption when used with the negative pressure massage machine, as the main case 10 has the negative pressure inlet 102 communicated to the negative pressure outlet 103. The first electrode member 20 and each of the second electrode members 30 of the beauty apparatus surround the periphery of the negative pressure inlet 102, and the gap 23 is formed between the first electrode member 20 and each of the second electrode members 30, such that the first electrode member 20 and each of the second electrode members 30 may form the circuit loop with the skin to achieve microcurrent stimulation. Therefore, the beauty apparatus may simultaneously perform vacuum adsorption and microcurrent stimulation on the skin. In addition, the beauty apparatus of the present disclosure includes the phototherapy module 60, the vibration motor 70, and the periocular massager 80 so as to achieve the effects of phototherapy, vibration, and periocular massage, and the functions do not interfere with each other and may be used simultaneously or independently to make the beauty apparatus of the present disclosure to have a multi-functional effect.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A beauty apparatus, comprising:
a main case, comprising an attaching portion, a negative pressure inlet, and a negative pressure outlet, the negative pressure inlet arranged on the attaching portion and communicated to the negative pressure outlet;
a first electrode member, arranged on the attaching portion and comprising a connection ring and a plurality of extending electrodes, the connection ring surrounding the negative pressure inlet, each of the extending electrodes extended from the connection ring in a direction away from the negative pressure inlet; and
a plurality of second electrode members, arranged on the attaching portion, surrounding the connection ring, and misaligned with each of the extending electrodes, wherein a gap is formed between the first electrode member and each of the second electrode members.

2. The beauty apparatus according to claim 1, wherein each of the extending electrodes is arranged radially, and each of the second electrode members and each of the extending electrodes are arranged in a staggered order and at intervals.

3. The beauty apparatus according to claim 1, wherein the first electrode member and each of the second electrode members are coplanar, and the first electrode member and each of the second electrodes members are electrodes with opposite electrical polarity.

4. The beauty apparatus according to claim 1, wherein the attaching portion is located on an end of the main case, and the negative pressure outlet is located on another end of the main case away from the negative pressure inlet.

5. The beauty apparatus according to claim 1, further comprising a connecting tube, wherein the connecting tube is arranged in the main case, two ends of the connecting tube are respectively communicated to the negative pressure inlet and the negative pressure outlet.

6. The beauty apparatus according to claim 1, wherein the main case comprises a first case and a second case, the first case is assembled to the second case, and the first case comprises the attaching portion.

7. The beauty apparatus according to claim 6, further comprising a third electrode member, wherein the third electrode member is a hollow ring and is sandwiched between the first case and the second case, and the first electrode member and the third electrodes member are electrodes with opposite electrical polarity.

8. The beauty apparatus according to claim 7, further comprising a pair of waterproof rings, wherein one of the waterproof rings is arranged between the first case and the third electrode member, and another one of the waterproof rings is arranged between the second case and the third electrode member.

9. The beauty apparatus according to claim 1, further comprising a phototherapy module, wherein the phototherapy module is arranged on the main case and comprises a base plate and a plurality of phototherapy lights, and each of the phototherapy lights is arranged on the base plate and configured to correspond to each of the gaps.

10. The beauty apparatus according to claim 9, wherein the phototherapy module further comprises a transparent cover, the transparent cover is arranged between the main case, the first electrode member, and each of the second electrode members.

11. The beauty apparatus according to claim 1, further comprising a periocular massager, wherein the periocular massager is detachably arranged on the main case and opposite to the attaching portion, and the periocular massager comprises a pair of convex cylinders arranged at intervals.

12. The beauty apparatus according to claim 11, wherein the convex cylinders are electrodes with opposite electrical polarity.

13. The beauty apparatus according to claim 1, further comprising an electronic control module, wherein the electronic control module is arranged in the main case and electrically connected to the first electrode member and each of the second electrode members.

14. The beauty apparatus according to claim 13, further comprising a vibration motor, wherein the vibration motor is arranged in the main case and electrically connected to the electronic control module.

15. The beauty apparatus according to claim 13, wherein the electronic control module comprises a circuit board and a power source, and the power source, the first electrode member and each of the second electrode members are electrically connected to the circuit board.
